(19) United States
(12) Patent Application Publication
(10) Pub. No.: US 2025/0183768 A1
(43) Pub. Date: Jun. 5, 2025

(54) A ROTOR

(71) Applicant: YASA LIMITED, Kidlington, Oxford, Oxfordshire (GB)

(72) Inventors: Callum PICKEN, Kidlington, Oxford, Oxfordshire (GB); Simon ODLING, Kidlington, Oxford, Oxfordshire (GB)

(21) Appl. No.: 18/852,390

(22) PCT Filed: Mar. 28, 2023
(86) PCT No.: PCT/EP23/57923

§ 371 Date: Sep. 27, 2024

(30) Foreign Application Priority Data
Mar. 30, 2022 (GB) 2204588.4

(51) Int. Cl. H02K 15/035; H02K 1/2798; H02K 21/24

(52) U.S. Cl. CPC H02K 15/035; H02K 1/2798; H02K 21/24

(57) ABSTRACT

A method of manufacturing a rotor of an axial flux permanent magnet machine, the machine having a stator comprising a set of coils wound on respective stator bars and disposed circumferentially at intervals about an axis of the machine, and a rotor comprising a rotor body bearing a set of permanent magnets on a layer of metal laminate and mounted for rotation about the axis, and wherein the rotor and stator are spaced apart along the axis to define a gap therebetween in which magnetic flux in the machine is generally in an axial direction, the method comprising: brazing the metal laminate to the rotor body; and joining the set of permanent magnets to the metal laminate.

### FIELD

This specification describes methods of manufacturing a rotor of an axial flux permanent magnet machine, rotors manufactured by the methods, and machines incorporating the rotors.

### BACKGROUND

An axial flux permanent magnet machine typically has disc- or ring-shaped rotor and stator structures arranged about an axis. The stator comprises a set of coils each of which may be parallel to the axis. The rotor, mounted on a bearing, carries a set of permanent magnets that are joined to the rotor by adhesive. The bearing allows the rotor to rotate about the axis driven by fields from the stator coils.

FIG. 1a shows the general configuration of an axial flux machine with a pair of rotors R1, R2 to either side of a stator S, although a simple structure could omit one of the rotors. There is an air gap G between a rotor and a stator, and in an axial flux machine a direction of magnetic flux through the air gap is substantially axial.

There are various configurations of axial flux permanent magnet machine depending upon the arrangement of north and south poles on the rotors. FIG. 1b illustrates the basic configurations of a Torus NS machine, a Torus NN machine (which has a thicker yoke because the NN pole arrangement requires flux to flow through the thickness of the yoke), and a YASA (Yokeless and Segmented Armature) topology. The illustration of the YASA topology shows cross-sections through two coils, the cross-hatched area showing the windings around each coil.

As described above, the permanent magnets in known axial flux permanent magnet machines are joined to the structural body of the rotor by adhesive, for example a polymer adhesive. The adhesive helps to maintain the relative position of magnets and may also electrically isolate the magnets from the rotor body to reduce eddy currents.

Eddy currents disadvantageously increase heat generation and reduce efficiency. To reduce eddy currents in the rotor body further, an intervening layer of laminated electrical steel may be provided between the magnets and the structural body of the rotor. The magnets are thus joined to the laminate by adhesive, and the laminate itself is joined to the rotor body by adhesive. The presence of the laminate and both adhesive layers electrically isolate the magnet from the rotor body thereby reducing eddy currents.

Whilst adhesive joins work well to locate magnets and reduce eddy currents, they undergo substantial stress and strain when subjected to the high temperatures and rotation speeds possible in the YASA topology. This increases the risk of component failure, for example through cracking and other breakages of the joins, and reduces the lifespan of the rotors.

Further, adhesive joins of laminate to rotor body are usually electrically insulating. Whilst this is not normally an issue in most applications, when certain types of mechanical machining are applied, for example grinding, lathe cutting or milling to achieve coplanarity of the laminate surface, these processes result in the exposed surface of the layers of the laminate becoming fused or smeared together at the machined surface thereby substantially reducing the ability of the laminate to prevent eddy currents, and subsequent de-burring processes are limited because of the laminate's electrical isolation. As a result, it is not straightforward to machine the surface of the laminate once it has been joined to the rotor body with adhesive and typically requires any machining and deburring to be done before the laminate is joined to the rotor, which can be impractical.

US2004/0250408A1 proposes a method of wrapping soft magnetic metal ribbon into a toroid and applying an adhesive to constrain the ribbon mechanically to overcome the problems associated with wire electrical discharge machining, electro-chemical grinding, conventional electrical discharge machining, cutting, stamping, acid etching and fine blanking.

US2004150285A1 proposes a method in which a plurality of layers of amorphous metal strips are laminated together adhesively to form a generally three-dimensional part. The adhesive means are said to afford sufficient structural integrity that permits the component to be handled and used, or incorporated into a larger structure.

US2004150285A1 emphasises that methods of forming laminations without producing burrs or other edge defects are preferred as the methods of US2004150285A1 are unable to easily remove such burrs or edge defects without damaging the laminate structure, for example by causing smearing at or near a cut surface.

### SUMMARY

In general terms, the problems of adhesively joining electrical steel laminate to a rotor body in the YASA topology are overcome by replacing the adhesive join between the rotor body and the laminate with a brazed join. The brazed join is stronger, more crack resistant, and more rigid than the adhesive join so is able to withstand higher temperatures and rotation speeds for longer without failing compared to when the laminate is joined to the rotor body using an adhesive. Synergistically the increased rigidity and join strength also allows higher intensity faster co-planarising machining processes, and, as the brazed join is metallic and electrically conductive, can be followed by electrically enhanced chemical etching processes such as ECM to remove inadvertently fused or smeared laminate layers caused by mechanical machining processes. Unlike many other machining processes, electrically enhanced etching processes such as ECM are suitable for implementation on a production line. Thus, the brazed join not only increases strength and rigidity of the rotor but also enables more efficient processes to be used on production lines. This approach goes against the approach of known methods which teach that the laminate should be electrically isolated (for example with adhesive) to reduce eddy currents. The present inventors have realised that any increase in eddy currents that may occur by the introduction of the brazed join is made up for by the advantages provided by a substantially stronger join and the enabling of efficient processes such as ECM. Furthermore the rigidity of a brazed laminate to rotor body join reduces the potential for damage to the interlaminate structure, i.e. delamination of the metal laminate as can occur when the metal laminate is joined using an adhesive. In particular, the rigid brazed join to the rotor body reduces relative movement of the interstitial layers when their surface is machined so they are able to withstand substantially stronger forces compared to when the laminate is joined to the rotor body using an adhesive. The machining can therefore be performed after the laminate has been joined to the rotor body, thereby simplifying the manufacturing process.

For example, the surface of the laminate facing away from the rotor body may be machined by lathe, milling, grinding, and/or CO₂ blasting in an initial machining step. However, advantageously the brazed join now allows these steps to be followed or even replaced with ECM to provide a highly coplanar, smooth and clean surface prior to the joining of the set of permanent magnets thereto without damaging the delicate laminated structure. A coplanar, smoother and cleaner surface between the laminate and the permanent magnets results in improved performance and lifetime of the rotor and physical integrity of the laminate and its electrical isolation between turns (that is, between layers of the interlaminate structure) and to adhered magnets help to reduce eddy currents in the rotor body. In contrast, if mechanical machining is applied to a laminate surface joined to the rotor body with adhesive, the lack of rigidity in the laminate may result in substantial damage to the laminated structure at the machined surface and at least the many advantages of ECM cannot be applied. Thus, in adhesive based approaches, the only options are either to apply less intensive machining techniques that result in a less smooth and more contaminated surface on which to join the permanent magnets, or simply not to perform any machining which results in substandard rotor performance and lifetime.

Thus, according to a first aspect, there is provided a method of manufacturing a rotor of an axial flux permanent magnet machine, the machine having a stator comprising a set of coils wound on respective stator bars and disposed circumferentially at intervals about an axis of the machine, and a rotor comprising a rotor body bearing a set of permanent magnets on a layer of metal laminate and mounted for rotation about the axis, and wherein the rotor and stator are spaced apart along the axis to define a gap therebetween in which magnetic flux in the machine is generally in an axial direction, The method comprises brazing the metal laminate to the rotor body and joining the set of permanent magnets to the metal laminate.

Optionally, the method comprises applying electro-chemical machining to a surface of the of the metal laminate after brazing the metal laminate to the rotor body and before said joining of the set of permanent magnets, to de-burr said surface.

Advantageously, as described above, ECM provides a highly coplanar, smooth and clean surface prior to the joining of the set of permanent magnets thereto without damaging the delicate laminated structure and is also highly suitable for implementation on a production line, unlike other de-burring methods.

Optionally, the method comprises applying a filling compound to the metal laminate to fill interlamination spaces of the metal laminate.

Advantageously, filling the interlamination spaces after the metal laminate is joined to the rotor body further enhances the rigidity of the laminated structure as the laminate layers are sandwiched between layers of filing compound. This further increases not only its ability to withstand the high rotational forces and temperatures generated by the YASA topology during operation, but also allows the structure to withstand higher forces during any subsequent machining process. Further, the filling compound allows the laminate to be machined without cutting or other machining fluids such as oils becoming entrapped between the laminate layers. In other words, the filling compound seals and electrically isolates adjacent laminate layers.

Optionally, the applying of the filling compound comprises performing vacuum pressure impregnation (VPI) with a resin.

VPI is a type of resin transfer moulding process in which the rotor body with metal laminate brazed thereto is fully submerged in a resin. Through combinations of dry and/or wet vacuum and/or pressure cycles, the resin is forced i.e. impregnated into the interlaminate spaces resulting in a monolithic structure comprising the resin and metal laminate. An example VPI process may comprise positioning the rotor body with joined laminate in a closed tool, drawing a vacuum and injecting resin, optionally under pressure, into the tool allowing it to permeate into the interlaminate spaces. The resin is then allowed to harden and cool to create a monolithic structure. Advantageously, the VPI process ensures that the impregnated resin is assimilated through most if not all of the laminate structure leaving no spaces. Not only does this increase the rigidity of the metal laminate as described above, but it also prevents any contaminants from entering these interlaminate spaces thereby improving rotor performance.

Optionally, the brazing comprises: applying a brazing compound to a surface of the rotor body; positioning the metal laminate on the brazing compound on the rotor body; and heating the brazing compound to join metal laminate to the rotor body. Optionally, the heating is performed with a hump back furnace or vacuum braze furnace.

Advantageously, one or both major surfaces of the rotor body, for example a disc like shape defining a central axial hole therethrough, may have a valley-like shape between two raised sides into which the laminate may be received. This valley-like shape thus advantageously provides a space into which brazing compound such as a brazing powder may be deposited using automated means on a production line. With the brazing compound deposited on the rotor body, the metal laminate may be placed thereon, whereby the raised sides help to position metal laminate accurately thereon. Once the laminate is placed on the rotor body with the brazing compound therebetween, heat is applied which melts the brazing compound which brazes the laminate to the rotor body to join them. A hump back furnace or vacuum braze furnace may advantageously be used as part of a production line for the method of the present disclosure to be implemented.

Optionally, the method may comprise quenching and tempering the rotor body and joined metal laminate. Optionally, the quenching comprises gas quenching.

Advantageously, quenching and tempering the rotor body and joined metal laminate ensures the desired metal grain structure is achieved. Advantageously, quenching in gas instead of, for example, oil, ensures there is no contamination between the layers of the laminate structure that would otherwise reduce performance and lifetime of the rotor.

Optionally, the method may comprise flattening the rotor body and metal laminate, for example with a press, to compensate for deformation which may occur during the brazing or heat treatment cycle after said quenching and tempering. The flattening is a plastic deformation of the assembly and may accordingly comprise bending the rotor body and metal laminate to a predetermined, e.g. flat, shape.

Optionally, prior to joining the metal laminate to the rotor body, the method comprises identifying which surface of the metal laminate is flatter than the other surfaces of the metal laminate, whereby the brazing is performed with the identified, flatter surface.

Typically, the metal laminate envisaged in the present disclosure is manufactured by winding sheet metal into a roll. This process results in one side of the metal laminate being smoother or flatter than the other. The inventors have realised that a brazed join of the flattest or smoothest surface results in a substantially stronger join to the rotor body thereby further enhancing and enabling the advantages of a more rigid laminate structure as described above. Thus, advantageously, identifying which surface of the metal laminate is the smoothest and using that surface to create the brazed join results in a rotor with improved performance.

Optionally, once the metal laminate has been brazed to the rotor body, the permanent magnets are joined to the metal laminate with an adhesive.

According to a second aspect, there is provided an axial flux permanent magnet machine comprising: a stator comprising a set of coils wound on respective stator bars and disposed circumferentially at intervals about an axis of the machine; a rotor bearing a set of permanent magnets on a layer of metal laminate and mounted for rotation about said axis, wherein said rotor and stator are spaced apart along the axis to define a gap therebetween in which magnetic flux in the machine is generally in an axial direction, wherein the rotor comprises a rotor body and a brazed join between the metal laminate and the rotor body.

Optionally, the metal laminate comprises an electro-chemically machined surface.

As described above, an electro-chemically machined surface is a highly coplanar, smooth and clean surface. Thus, it improves the performance and lifetime of the rotor and physical integrity of the laminate and its electrical isolation between turns and to adhered magnets to help reduce eddy currents in the rotor body compared to a metal laminate surface machined using other techniques.

Optionally, the axial flux permanent magnet machine comprises a filling compound, for example a resin, in interlamination spaces of the metal laminate.

Optionally, the axial flux permanent magnet machine comprises an adhesive join between the metal laminate and the set of permanent magnets and the metal laminate.

As will be appreciated, the axial flux permanent magnet machine described herein has all of the advantages described above in connection with the described method. These advantages are provided by the increased strength and rigidity, and electrical conductivity resulting from the brazed join between the metal laminate and rotor body, and/or from the filling compound in the metal laminate.

According to a third aspect, there is provided a rotor of an axial flux permanent magnet machine, the rotor comprising: a rotor body bearing a set of permanent magnets on a layer of metal laminate; and a brazed join between the metal laminate and the rotor body.

As will be appreciated, the rotor described herein has all of the advantages described above in connection with the described method. These advantages are provided by the increased strength and rigidity, and the electrical conductivity, resulting from the brazed join between the metal laminate and rotor body, and/or from the filling compound in the metal laminate.

According to a fourth aspect, there is provided a method of joining metal laminate to a rotor body of a rotor, the method comprising: applying a brazing compound to a surface of the rotor body; positioning the metal laminate on the brazing compound on the rotor body; and heating the brazing compound to join the metal laminate to the rotor body.

Optionally, the method comprises applying electro-chemical machining to a surface of the metal laminate after brazing the metal laminate to the rotor body to de-burr said surface.

Optionally, the method comprises applying a filling compound to the metal laminate to fill interlamination spaces of the metal laminate.

Advantageously, method of the present disclosure is not limited to manufacturing the rotor of the axial flux permanent magnet machine described above. It may also be used generally to join metal laminate to a rotor body of any type of rotor to provide the above-described advantages.

According to a fifth aspect, there is provided a method of machining metal laminate, the method comprises applying electro-chemical machining to a surface of the metal laminate.

Advantageously, method of the present disclosure is not limited to manufacturing the rotor of the axial flux permanent magnet machine described above or indeed to joining metal laminate to a rotor. In particular, the present methods provide the above-described advantages when used generally to machine any metal laminate.

For example, this method may particularly be applied to efficiently and effectively deburr and smooth a surface of a disc or toroidal shaped piece of metal laminate produced by winding sheet metal round a central axis, the metal laminate layers running parallel to and/or around said axis. The method is accordingly particularly suited to scenarios where it is desired to ensure the laminate layers do not become joined, smeared or otherwise fused together. That is, the method is particularly effective at preventing smearing or damage that may be caused by other machining or deburring methods at the machined surface. Such pieces of metal laminate find uses in electric motors, generators and other magnet machines, and in their components, but also in other devices and systems. Thus, in one example, the piece metal laminate referred to in this method may be said to be a piece of metal laminate of an electric motor, generator and/or other magnet machine.

An axial flux permanent magnet machine as described above, and as used in the above-described methods, may be, for example, a motor or a generator.

### BRIEF DESCRIPTION OF THE DRAWINGS

These and other aspects of the invention will now be further described, by way of example only, with reference to the accompanying figures in which:

FIGS. 1a to 1c show, respectively, a general configuration of a two-rotor axial flux machine, example topologies for axial permanent magnet machines including a schematic side view of a yokeless and segmented armature (YASA) machine, and an enumerated drawing of a YASA machine.

FIG. 2 shows a perspective view of the YASA machine of FIG. 1c.

FIG. 3 shows a perspective exploded view of a stator and stator housing for a YASA machine.

FIG. 4 shows an exploded view of a rotor of an axial flux permanent magnet machine of the present invention.

FIG. 5a shows a metal laminate 403 joined to a rotor body after brazing.

FIG. 5b shows a cross section through line A-A of FIG. 5a.

FIG. 6a illustrates an exemplary VPI tool.

FIG. 6b shows a cross section of part of a rotor body and metal laminate with applied filling compound.

FIG. 7 shows a cross section of an assembled rotor according to the present disclosure.

FIG. 8 illustrates a method according to the present disclosure.

FIG. 9 illustrates a method according to the present disclosure.

FIG. 10 illustrates a method according to the present disclosure.

Like elements are indicated by like reference numerals.

### DETAILED DESCRIPTION

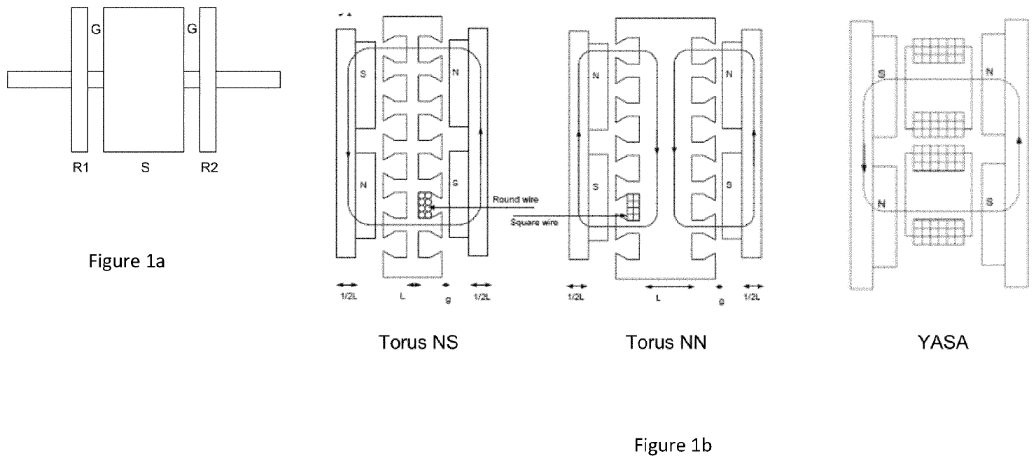

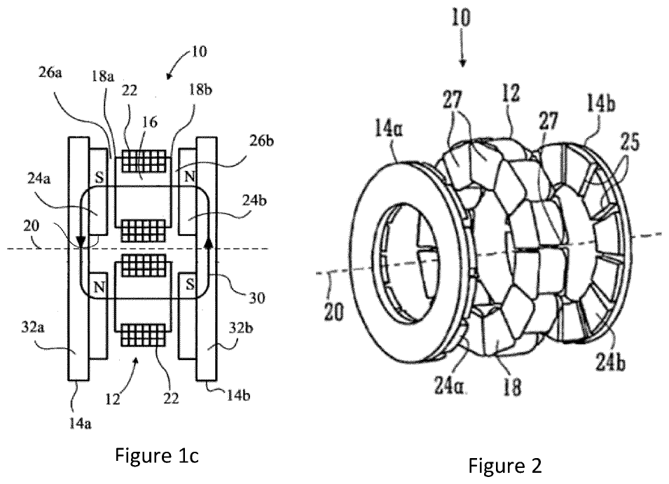

FIGS. 1c, 2 and 3, which are taken from WO2012/022974, 1c show details of an example yokeless and segmented armature (YASA) machine 10. The machine 10 may function either as a motor or as a generator.

The machine 10 comprises a stator 12 and, in this example, two rotors 14a,b. The stator 12 comprises a collection of separate stator bars 16 spaced circumferentially about a machine axis 20, which also defines an axis of the rotors 14a,b. Each bar 16 carries a stator coil 22, and has an axis which is typically disposed parallel to the rotation axis 20. Each end 18a,b of the stator bar is provided with a shoe 27, which helps to confine coils of the stator coil 22 and may also spread the magnetic field generated by the stator coil. The stator coil 22 may be formed from square or rectangular section insulated wire so that a high fill factor can be achieved. In a motor the stator coils 22 are connected to an electrical circuit (not shown) that energizes the coils so that poles of the magnetic fields generated by currents flowing in the stator coils are opposite in adjacent stator coils 22.

The two rotors 14a,b carry permanent magnets 24a,b that face one another with the stator coil 22 between. When the stator bars are inclined (not as shown) the magnets are likewise inclined. Gaps 26a,b are present between respective shoe and magnet pairs 17/24a, 27/24b. In an example motor the stator coils 22 are energized so that their polarity alternates to cause coils at different times to align with different magnet pairs, resulting in torque being applied between the rotor and the stator.

The rotors 14a,b are generally connected together, for example by a shaft (not shown), and rotate together about the machine axis 20 relative to the stator 12. In the illustrated example a magnetic circuit 30 is formed by two adjacent stator bars 16, two magnet pairs 24a,b, and two back plates 32a,b, one for each rotor, linking the flux between the backs of each magnet pair 24a,b facing away from the respective coils 22. The back plates 32a,b may be referred to as back irons and comprise a magnetic material, typically a ferromagnetic material although not necessarily iron. This magnetic material is not required to be a permanent magnet. The stator coils 16 are enclosed within a housing which defines a chamber for the rotors and stator, and which may be supplied with a cooling medium.

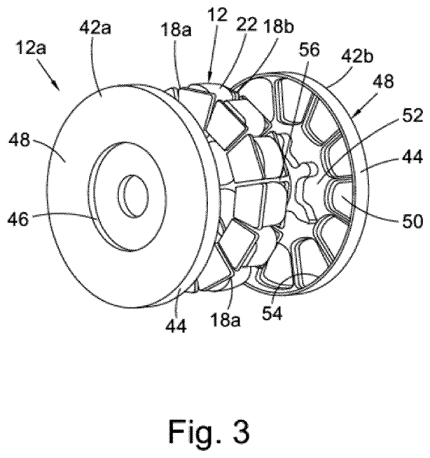

FIG. 3 shows a stator 12a in which the stator coils are located between plastics material clam shells 42a,b. These clamshells have external cylindrical walls 44, internal cylindrical walls 46, and annular end walls 48. In FIG. 3 the end walls 48 include internal pockets 50 to receive the shoes 18a,b of the stator bars 16 and serve to locate the stator coil assemblies 16, 22, 18a,b when the two clam shell housings 42a,b of the stator 12a are assembled together. The stator housing 42a,b defines spaces 52 internally of the coils 22 and externally at 54 around the outside of the coils 22, and there are spaces 56 between the coils. The spaces 52, 54, 56 are interlinked defining a cooling chamber. Although not shown in FIG. 3, when assembled the stator housing 42a,b is provided with ports that allow cooling medium such as oil to be pumped into the spaces 52, 54, 56 to circulate around the coils and cool them.

The coil cores may be laminated with the inter-lamination insulation parallel to the desired flux direction. However the coil cores may also be formed from soft-iron particles coated with electrical insulation and moulded to a desired shape (soft magnetic composites-SMC), being bound together by the insulation matrix. An example SMC may comprise glass-bonded iron particles, a thin layer (typically <10 μm) of glass bonding and mutually electrically insulating the iron particles, leaving some residual porosity. The shoes 27 may be moulded from SMC, e.g. using a high-temperature, high-pressure compaction process. Conveniently, the shoes and stator bar may be formed separately and subsequently assembled.

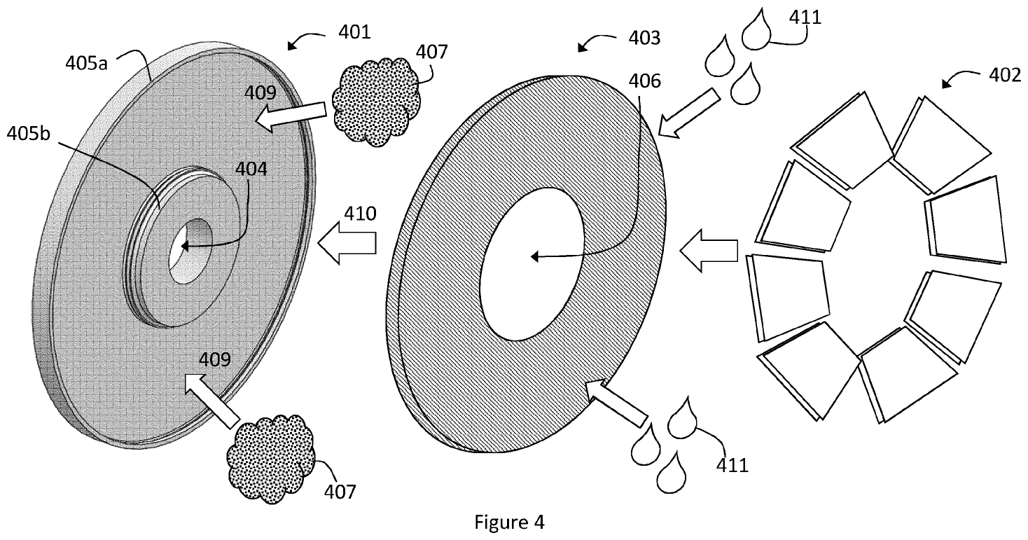

FIG. 4 shows an exploded view of a rotor of an axial flux permanent magnet machine of the present invention. The rotor comprises a rotor body 401 bearing a set of permanent magnets 402 on a layer of metal laminate 403. That is, the metal laminate 403 has an internal structure made up of electrically isolated layers that help to reduce eddy currents.

The rotor body 401 may be constructed from a metal such as steel to provide structural strength to the rotor and defines an axial hole 404 through its centre. The rotor body in FIG. 4 is provided with a raised portion or outer wall 405a around the outer circumference and a raised portion or inner wall 405b around the inner circumference which together result in valley-like or U-shape on a major surface of the rotor body in which to receive and to help position the metal laminate 403. The shape of the rotor body 401 may be pressed or machined to a desired tolerance in advance of the positioning of the metal laminate 402 thereon.

The metal laminate 403 may comprise, for example, electrical steel. Other suitable materials are also envisaged. Whilst not shown, the metal laminate 403 is created by winding sheet metal of a desired width and thickness into a roll of a desired diameter to provide a spiral-like or concentric ring-like interlaminate structure around an axial hole 406 with a space between the layers determined by the winding tightness. The space electrically isolates the layers of the metal laminate 403 from immediately adjacent layers to minimise eddy currents in the metal laminate 403 and to magnetically isolate the rotor body 401 from the permanent magnets 402 joined to the surface of the metal laminate 403 to prevent eddy currents in the rotor body 401.

The set of permanent magnets 402 in FIG. 4 are provided as segmented magnets shaped to enable their arrangement into a ring matching the shape of the rotor body and metal laminate. However, it is envisaged that other shapes and arrangements of permanent magnets, for example a single monolithic ring magnet, may also be used as determined by the given application.

In order to assemble the rotor of FIG. 4, a brazing compound 407, such as a powder, for example a nickel-based brazing powder, is deposited onto the surface of the rotor body 401 onto which the metal laminate 403 will be brazed. The metal laminate 403 is then positioned 410 onto the surface of the rotor body and heat is applied. As will be appreciated, brazing requires a heat that is sufficient to melt the brazing compound 407 but is not so hot as to melt the parent materials being joined. For example, depending on the brazing compound used, a heat of around 600-1200° C., for example, around 1100° C. may be used. The heat may be applied using a furnace such as a hump back furnace, which may be a belt-type, hump back furnace when part of a production line, or a vacuum braze furnace. After heating, the brazing compound cools and solidifies thereby joining the metal laminate 403 to the rotor body 401 with a brazed join.

Optionally, quenching (for example in an inert gas such as nitrogen or an alternative) and if required tempering may be performed to achieve a desired metal grain structure as will be appreciated by the skilled person.

After the metal laminate 403 is brazed to the rotor body 401, an adhesive 411, for example a polymer adhesive, is applied to the exposed face of the metal laminate 403 and the set of permanent magnets 402 are positioned thereon in the desired positions to complete the adhesive join to the metal laminate 403.

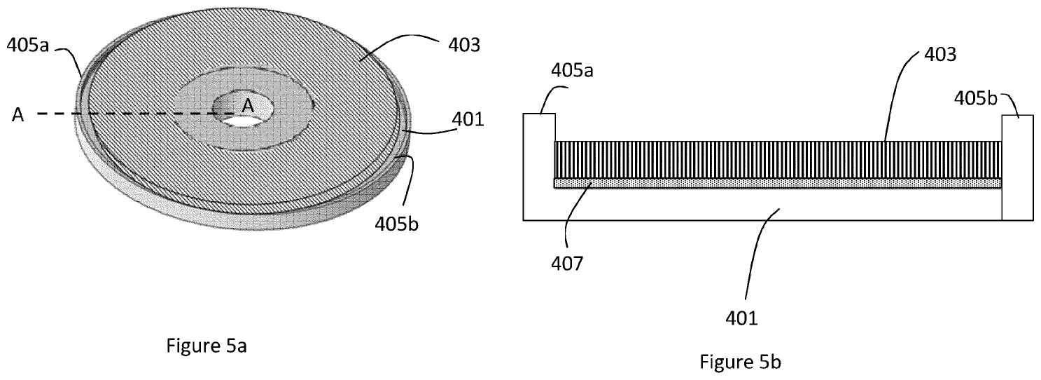

FIGS. 5a and 5b illustratively show the metal laminate 403 joined to the rotor body after brazing is complete. FIG. 5b shows a cross section through the line A-A of FIG. 5a. As described above, the brazed join provided by brazing compound 407 after heating and cooling rigidly secures the layers of laminate in their positions on the rotor body. The layers of laminate visible in FIG. 5b provides an example of the interlamination structure, namely the layers of the roll of sheet metal are provided in a spiral-like or concentric ring-like manner with spaces between them around the valley or U-shape provided by the raised portions or walls 405a, 405b of the rotor body 401. The layers of laminate are aligned in a direction extending away from the rotor body 401.

Optionally, the metal laminate 403 and rotor body 401 may be flattened or otherwise plastically deformed to achieve a desired flatness for a given application after the brazing is complete. This may be done, for example, in a press or other tool.

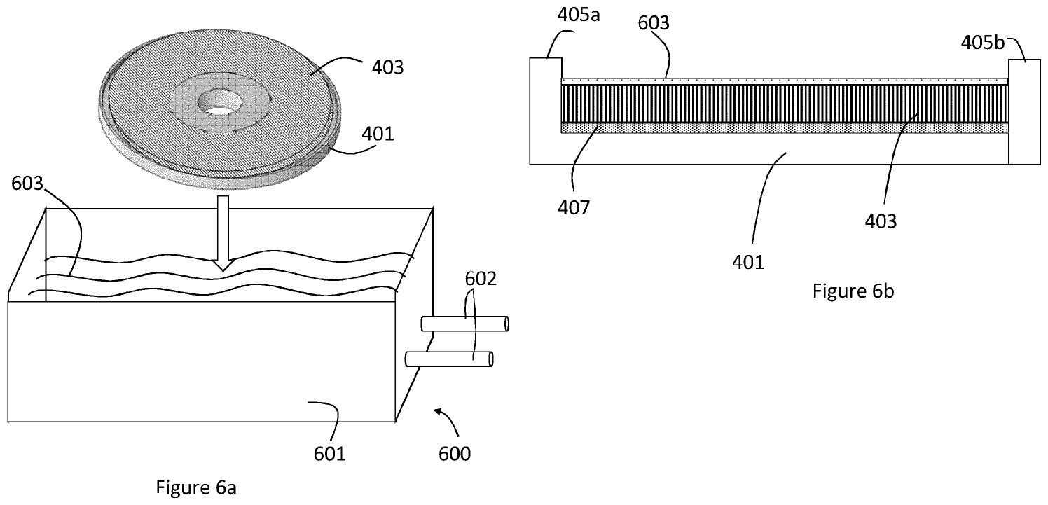

FIGS. 6a and 6b illustratively show the optional step of providing a filling compound, such as a resin, to fill the interlaminate spaces of the metal laminate 403 after it has been brazed to the rotor body 401. As described above, VPI may be used. FIG. 6a illustrates an exemplary VPI tool 600 with an enclosable space 601 with one conduits 602 with which wet and dry vacuum cycles with a filling compound 603 such as resin may be performed to impregnate the filling compound into the interlaminate spaces of the metal laminate 403.

FIG. 6b illustratively shows a cross section similar to that of FIG. 5b but now showing a cross section after the filling compound 603 has been applied and the metal laminate 403 is impregnated with the filling compound 603. As described above, the filling compound further increases the strength and rigidity of the laminate structure of the metal laminate 403.

FIG. 6b further shows that a layer of filling compound 603 may remain on an upper surface of the metal laminate 403. However, as described above, the increased strength of the brazed join 407 allows physical machining techniques to be applied with a reduced risk of damaging the laminate. Further, the electrical conductivity of the brazed join now also allows ECM to be applied to remove deburr the outer surface of the metal laminate 403 to provide the advantages of ECM described herein that are not possible with other types of de-burring. In this way, the exposed surface of the metal laminate 403 may be clean, coplanar and smooth prior to the joining of the set of permanent magnets by adhesive 411 thereby improving the performance and lifetime of the rotor and physical integrity of the laminate and its electrical isolation between turns.

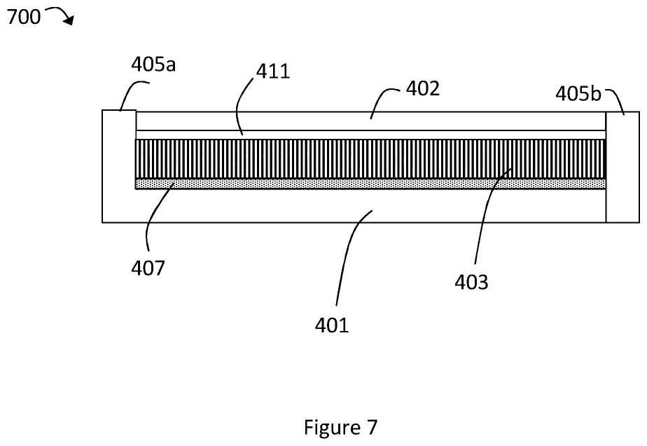

FIG. 7 illustratively shows a cross section of an assembled rotor 700 according to the present disclosure through a line corresponding to the line A-A in FIG. 5a. Like elements are indicated by like reference numerals. As described above, the rotor comprises a rotor body 401, a set of permanent magnets 402 and a layer of metal laminate 403. The metal laminate 403 and rotor body 401 are joined by a brazed join 407 whereas the set of permanent magnets 402 and metal laminate are joined by an adhesive join 411. The upper surface of the metal laminate 403 (that is, the surface facing away from the rotor body 401) may be an electro-chemically machined surface.

As described above, when assembled, the rotor may be positioned in axial alignment with the stator of FIG. 3 to create an axial flux permanent magnet machine having the YASA topology.

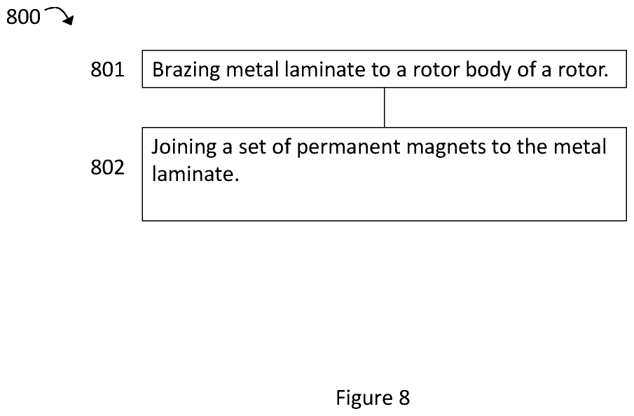

FIG. 8 is a flow chart of a method 800 of manufacturing a rotor of an axial flux permanent magnet machine, according to the present disclosure. The machine has a stator comprising a set of coils wound on respective stator bars and disposed circumferentially at intervals about an axis of the machine, and a rotor comprising a rotor body bearing a set of permanent magnets on a layer of metal laminate and mounted for rotation about the axis, and wherein the rotor and stator are spaced apart along the axis to define a gap therebetween in which magnetic flux in the machine is generally in an axial direction. The method 800 comprises brazing 801 the metal laminate to the rotor body, and joining 802 the set of permanent magnets to the metal laminate.

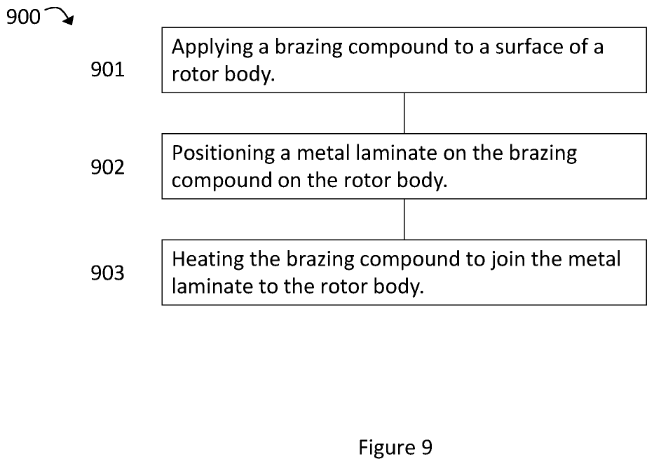

FIG. 9 is a flow chart of a method 900 of joining metal laminate to a rotor body of a rotor, according to the present disclosure. The method 900 comprises applying 901 a brazing compound to a surface of the rotor body, positioning 902 the metal laminate on the brazing compound on the rotor body, and heating 903 the brazing compound to join the metal laminate to the rotor body.

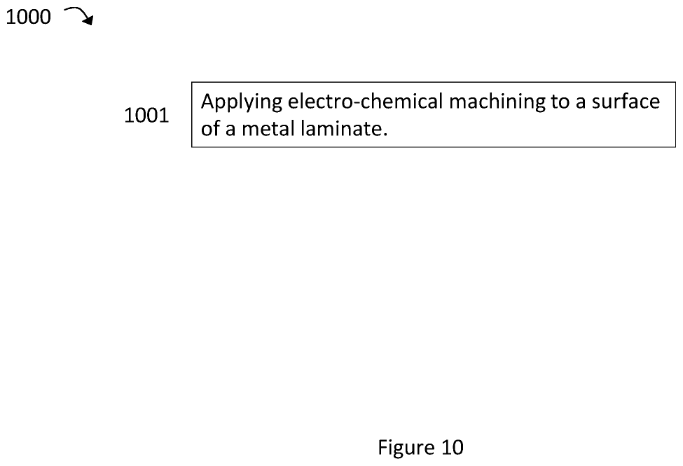

FIG. 10 is a flow chart of a method 1000 of machining metal laminate according to the present disclosure. The method 1000 comprises applying 1001 electro-chemical machining to a surface of the metal laminate.

The terms upper and lower surface, and the horizontal and vertical directions as used herein are used to describe the relative positioning of said surfaces and directions relative to each other and are not intended to limit the present disclosure to any given orientation in a coordinate system. The terms upper and lower, and horizontal and vertical are used for convenience of illustration relative to the figures provided herein. Thus, the upper surface is on an opposite side of a feature to the lower surface. Similarly, the inner surface is on an opposite of a feature to the outer surface regardless of the orientation of the feature in the coordinate system.

No doubt many other effective alternatives will occur to the skilled person. It will be understood that the invention is not limited to the described embodiments and encompasses modifications apparent to those skilled in the art lying within the scope of the claims appended hereto.

For example, whilst the brazing compound is said to be applied to the rotor body, the other way around is also envisaged. For example, the brazing compound may instead be applied to the metal laminate and the rotor body may be placed thereon prior to brazing. Similarly, whilst adhesive is said to be applied to the metal laminate before the magnets are placed thereon, it is also envisaged that the other way around is possible. For example, adhesive may instead be applied to the magnets instead to achieve the same desired effect.

The invention claimed is:

1. A method of manufacturing a rotor of an axial flux permanent magnet machine, the machine having a stator comprising a set of coils wound on respective stator bars and disposed circumferentially at intervals about an axis of the machine, and a rotor comprising a rotor body bearing a set of permanent magnets on a layer of metal laminate and mounted for rotation about the axis, and wherein the rotor and stator are spaced apart along the axis to define a gap therebetween in which magnetic flux in the machine is generally in an axial direction,
the method comprising:
brazing the metal laminate to the rotor body; and
joining the set of permanent magnets to the metal laminate.

2. The method of claim 1, comprising applying electro-chemical machining to a surface of the of the metal laminate after brazing the metal laminate to the rotor body and before said joining of the set of permanent magnets, to de-burr said surface.

3. The method of claim 1, comprising applying a filling compound to the metal laminate to fill interlamination spaces of the metal laminate.

4. The method of claim 3, wherein the applying of a filling compound comprises performing vacuum pressure impregnation with a resin.

5. The method of claim 1, wherein the brazing comprises:
applying a brazing compound to a surface of the rotor body;
positioning the metal laminate on the brazing compound on the rotor body; and
heating the brazing compound to join metal laminate to the rotor body.

6. The method of claim 5, wherein the heating is performed with a hump back furnace or vacuum braze furnace.

7. The method of claim 5, comprising quenching and tempering the rotor body and joined metal laminate.

8. The method of claim 7, wherein the quenching comprises nitrogen quenching.

9. The method of claim 5, comprising flattening the rotor body and metal laminate after said quenching and tempering.

10. The method of claim 1, comprising identifying which surface of the metal laminate is flatter than the other surfaces of the metal laminate, and wherein the brazing is performed with the identified surface.

11. The method of claim 1, wherein the permanent magnets are joined to the metal laminate with an adhesive.

12. An axial flux permanent magnet machine comprising:
a stator comprising a set of coils wound on respective stator bars and disposed circumferentially at intervals about an axis of the machine;
a rotor bearing a set of permanent magnets on a layer of metal laminate and mounted for rotation about said axis, wherein said rotor and stator are spaced apart along the axis to define a gap therebetween in which magnetic flux in the machine is generally in an axial direction,
wherein the rotor comprises a rotor body and a brazed join between the metal laminate and the rotor body.

13. The axial flux permanent magnet machine of claim 12, wherein the metal laminate comprises an electro-chemically machined surface.

14. The axial flux permanent magnet machine of claim 13, comprising a filling compound provided in interlamination spaces of the metal laminate.

15. The axial flux permanent magnet machine of claim 14, wherein the filling compound comprises a resin.

16. The axial flux permanent magnet machine of claim 13, comprising an adhesive join between the metal laminate and the set of permanent magnets and the metal laminate.

17. A rotor of an axial flux permanent magnet machine, the rotor comprising:
a rotor body bearing a set of permanent magnets on a layer of metal laminate; and
a brazed join between the metal laminate and the rotor body.

18. A method of joining metal laminate to a rotor body of a rotor, the method comprising:
applying a brazing compound to a surface of the rotor body;
positioning the metal laminate on the brazing compound on the rotor body; and
heating the brazing compound to join the metal laminate to the rotor body.

19. The method of claim 18, comprising applying electro-chemical machining to a surface of the metal laminate after brazing the metal laminate to the rotor body to de-burr said surface.

20. The method of claim 18, comprising applying a filling compound to the metal laminate to fill interlamination spaces of the metal laminate.

21. (canceled)
